(19) United States
(12) Patent Application Publication
(10) Pub. No.: US 2011/0072943 A1
(43) Pub. Date: Mar. 31, 2011

(54) RIVING KNIFE ADJUSTMENT MECHANISM FOR A SAW MACHINE

(75) Inventor: Jung-Huo CHEN, Taichung (TW)

(73) Assignee: REXON INDUSTRIAL CORP., LTD., Taichung (TW)

(21) Appl. No.: 12/882,381

(22) Filed: Sep. 15, 2010

(30) Foreign Application Priority Data
Sep. 29, 2009 (TW) 098132925

(51) Int. Cl. B27G 19/08

(52) U.S. Cl. 83/102.1

(57) ABSTRACT

A saw machine riving knife adjustment mechanism includes a locating member, which defines a track, a riving knife, which has a coupling portion inserted into the track and a riving knife body, and a locking unit, which includes a brake affixed to the locating member and two retaining members movable by the brake. The brake is operable between a locking position, where the retaining members are engaged with first retaining holes or second retaining holes to lock the riving knife in position, and an unlocking position where the retaining members are disengaged from the first retaining holes or second retaining holes to unlock the riving knife.

This application claims, under 35 U.S.C. §119, priority to Taiwanese Application No. 098132925, filed Sep. 29, 2009, which application is hereby incorporated by reference in its entirety, inclusive of the specification, claims, and drawings.

### FIELD OF THE INVENTION

The present disclosure relates to saw machines and more specifically, to a riving knife adjustment mechanism for a saw machine.

### BACKGROUND

A saw machine has safety devices to protect the operator from injury. For example, a riving knife is fixedly mounted on the machine base behind the saw blade to prevent a phenomenon known as kickback, which occurs when the wood being cut is caught by the rear edge of the saw blade, lifted off the table and propelled backwards toward the operator.

Such safety devices typically require adjustment. In particular, when changing out different sizes of saw blades for cutting different thickness of wooden materials, or different saw blade working conditions, the height of the saw blade may have to be adjusted up and down. In such a case, the riving knife may also have to be adjusted subject to the position of the saw blade. Therefore, it is a desired function of a saw machine to allow quick mounting, dismounting and adjustment of the riving knife.

U.S. Pat. No. 6,840,144 B2 discloses a riving knife mounting structure, as reproduced in FIG. 1, which includes a control plate 1 having a sloping face 102, and which is movable to control a spring-loaded pin 2, causing the spring-loaded pin 2 to engage with a retaining hole 301 on a riving knife 3 or to move away from the retaining hole 301. Thus, the riving knife 3 can be adjusted vertically or detached from the machine for replacement.

Additionally, U.S. Pat. No. 7,437,981 B2, Taiwan Patent No. TW 1305160 and TW M280905 also disclose quick-detachable, quick-adjustable riving knife mounting structures.

The structure disclosed in U.S. Pat. No. 6,840,144 B2 (as shown in FIG. 1) allows quick adjustment or replacement of the riving knife 3 on a mounting frame 4. However, when adjusting or replacing the riving knife 3, the operator must insert a hand into the inside of the machine base of the saw machine (not shown) to operate the control plate 1 within a narrow space. As such, it is inconvenient to operate this structure. U.S. Pat. No. 7,437,981 B2, Taiwan Patent No. TW 1305160 and TW M280905 also disclose structures that have the same problem.

### SUMMARY

The present disclosure has been accomplished under the circumstances in view. Accordingly, embodiments of the present disclosure provide a riving knife adjustment mechanism for a saw machine, which is easy to operate and allows for quick adjustment.

In particular, a riving knife adjustment mechanism is installed in a machine base of a saw machine that has a top wall. The riving knife adjustment mechanism includes a locating member, a riving knife, and a locking unit. The locating member is fixedly mounted in the machine base below the top wall, and defines a track that extends along a longitudinal direction toward the top wall. The riving knife has a coupling portion slidably inserted into the track of the locating member.

The coupling portion has at least one first retaining hole and at least one second retaining hole spaced from the at least one first retaining hole in the longitudinal direction. The locking unit comprises a brake pivotally connected to the locating member, and at least one spherical retaining member controllable by the brake to engage the at least one first retaining hole or the at least one second retaining hole of the riving knife, or to move away from the at least one first retaining hole or at least one second retaining hole of the riving knife.

In another embodiment, a riving knife adjustment mechanism is installed in a machine base of a saw machine that has a top wall. The riving knife adjustment mechanism includes a locating member, a riving knife and a locking unit. The locating member is fixedly mounted in the machine base below the top wall, and includes a base member, a constraint plate affixed to the base member, and a track defined between the base member and the constraint plate and extending along a longitudinal direction toward the top wall.

The constraint plate has at least one through hole in communication with the track. The riving knife has a coupling portion slidably inserted into the track of the locating member. The coupling portion has at least one first retaining hole. The locking unit includes a brake pivotally connected to the constraint plate, and at least one spherical retaining member controllable by the brake to engage through the at least one through hole into the at least one first retaining hole of the riving knife or to move away from the at least one first retaining hole.

Operating the brake moves the retaining members into or out of the first or second retaining holes to lock or unlock the riving knife, and therefore the adjustment of the position of the riving knife is quick and simple.

### BRIEF DESCRIPTION OF THE DRAWINGS

FIG. 1 is an exploded view of a riving knife adjustment mechanism according to the prior art.

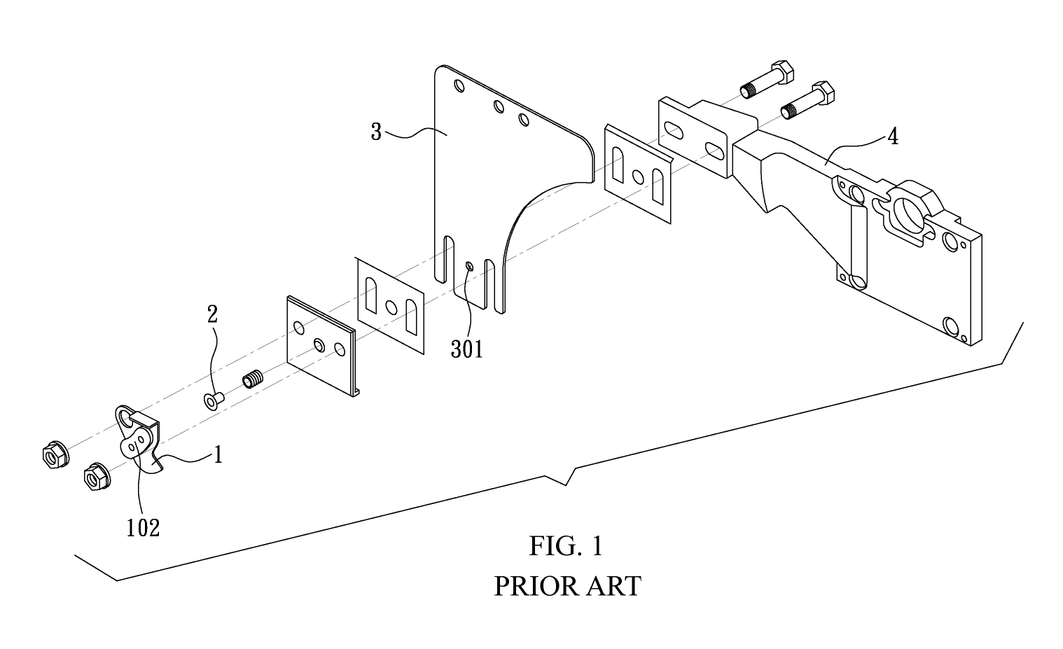

FIG. 2 is an exploded view of a riving knife adjustment mechanism in accordance with a first embodiment of the present disclosure.

FIG. 3 is a plain assembly view of the first embodiment of the present disclosure, showing the riving knife in the topmost position.

FIG. 4 is a sectional view taken along line IV-IV of FIG. 3.

FIG. 5 is a sectional view taken along line V-V of FIG. 4.

FIG. 6 corresponds to FIG. 4, showing the pull knob of the locking unit in a lifted position.

FIG. 7 is a schematic operational view of the first embodiment of the present disclosure, showing the riving knife in the lowest position.

FIG. 8 is a sectional view taken along line VIII-VIII of FIG. 7.

FIG. 9 is a sectional view taken along line IX-IX of FIG. 8.

FIG. 10 is an exploded view of a riving knife adjustment mechanism in accordance with a second embodiment of the present disclosure.

FIG. 11 is a plain assembly view of the second embodiment of the present disclosure, showing the riving knife in the topmost position.

FIG. 12 is a sectional view taken along line XII-XII of FIG. 11.

FIG. 13 is a schematic operational view of the second embodiment of the present disclosure, showing the riving knife in the lowest position.

FIG. 14 is a sectional view taken along line XIV-XIV of FIG. 13.

### DETAILED DESCRIPTION

Other and further technical features, benefits and advantages of the present disclosure will be understood by reference to the description of the following two examples in conjunction with the accompanying drawings, in which like reference characters denote like elements of structure.

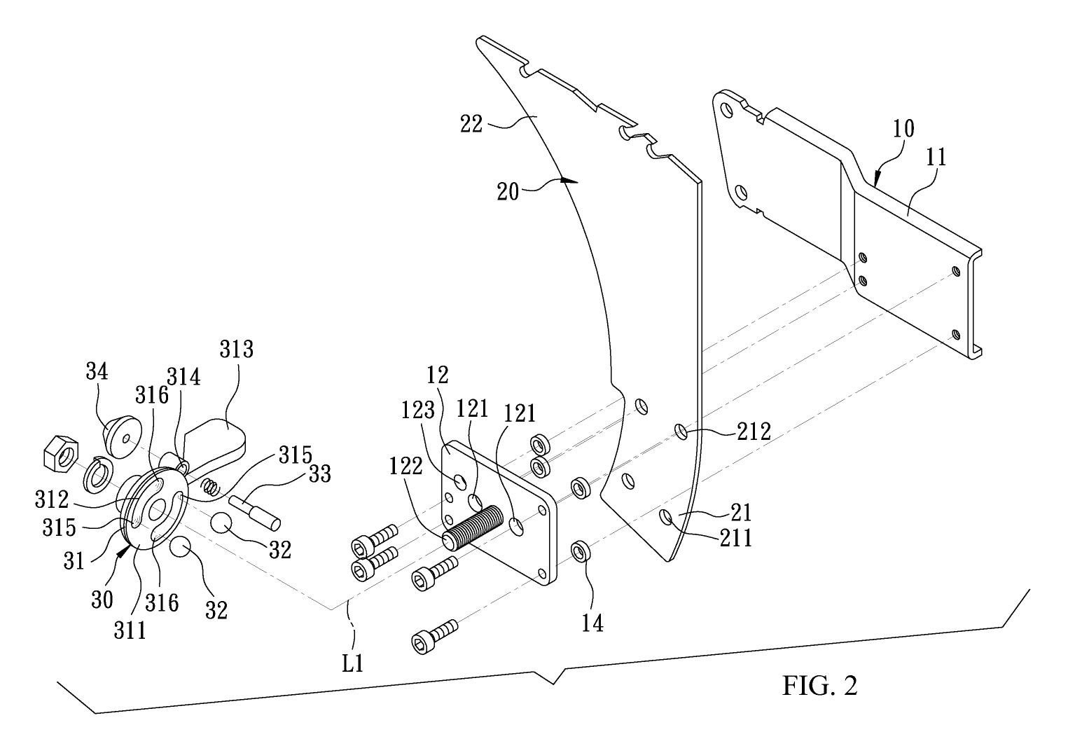

Referring to FIGS. 2, 3 and 4, a riving knife adjustment mechanism in accordance with a first embodiment of the present disclosure is shown installed in a machine base 100 that has a top wall 110. The riving knife adjustment mechanism includes a locating member 10, a riving knife 20, and a locking unit 30.

The locating member 10 is affixed to the machine base 100 below the top wall 110. Further, the locating member 10 includes a base member 11, a constraint plate 12 affixed to the base member 11, a plurality of washers 14 set between the base member 11 and the constraint plate 12, and a track 13 defined by the washers 14 between the base member 11 and the constraint plate 12. The constraint plate 12 has two through holes 121 disposed in communication with the track 13, an axle 122 extending along a first axis L1 between the two through holes 121 and a locating hole 123 disposed at one side relative to the track 13. The track 13 extends along a longitudinal direction X toward the top wall 110.

The riving knife 20 has a coupling portion 21 slidably inserted into the track 13 in the locating member 10, and a riving knife body 22 connected to one side of the coupling portion 21 and facing the top wall 110. The coupling portion 21 has two first retaining holes 211, and two second retaining holes 212 spaced from the first retaining holes 211 along the longitudinal direction X.

The locking unit 30 comprises a brake 31 pivotally connected to the constraint plate 12, two retaining members 32 controlled by the brake 31, a spring-loaded locating pin 33 mounted on the brake 31 and a pull knob 34 mounted on the rear end of the spring-loaded locating pin 33.

The brake 31 is mounted on an axle 122 of the constraint plate 12 and is rotatable on the first axis L1. The brake 31 includes a bottom wall 311, two recessed brake portions 312 located on the bottom wall 311 and corresponding to the two through holes 121, a handle 313 extended from the periphery, and a stepped hole 314 disposed adjacent to the handle 313 at one side thereof.

The recessed brake portions 312 are in the form of arc shaped grooves arranged around the first axis L1, each having opposing shallow ends 315 and a deep ends 316. Each deep end 316 of each arc shaped groove has a depth greater than the shallow end 315.

The retaining members 32 are spherical members, for example, steel balls. When the retaining members 32 are respectively moved to the shallow ends 315 of the recessed brake portions 312, they partially protrude through the through holes 121 and into the first retaining holes 211 or into the second retaining holes 212. The spring-loaded locating pin 33 is mounted in the stepped hole 314 for engaging the locating hole 123.

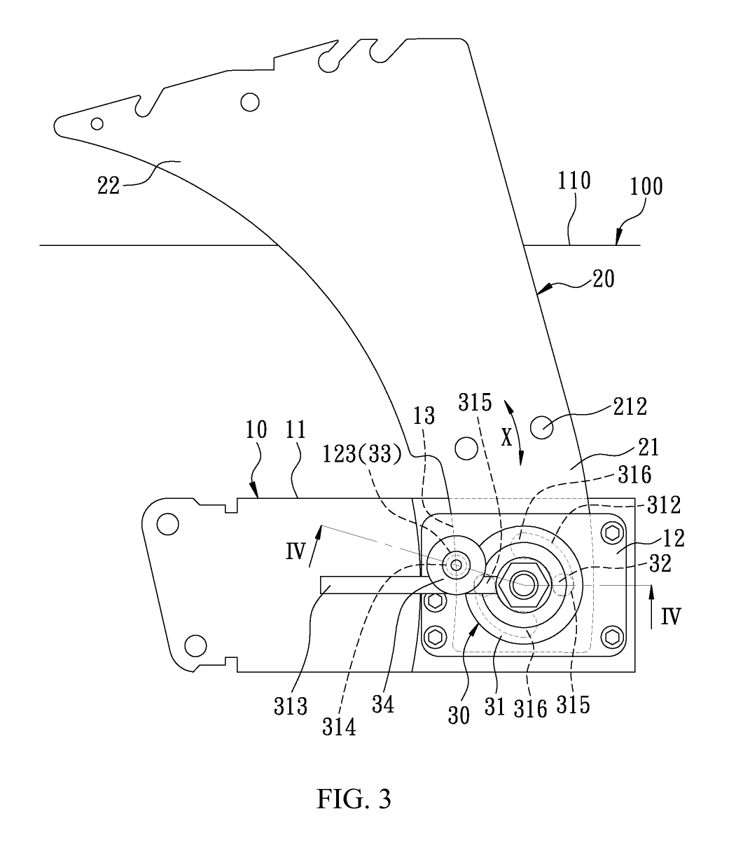

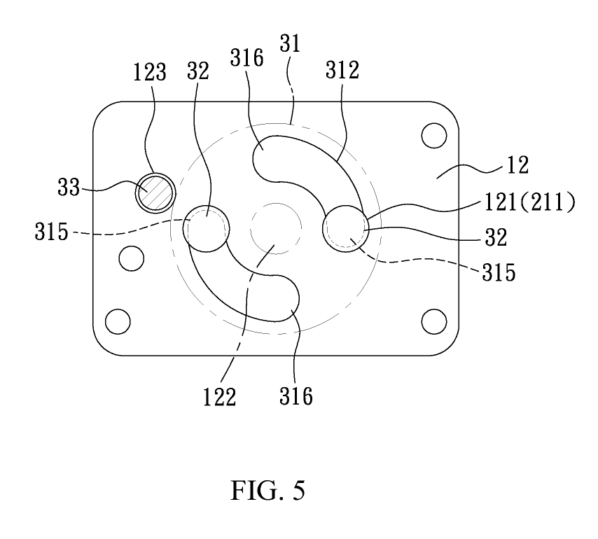

Referring to FIGS. 3, 4 and 5, the riving knife body 22 of the riving knife 20 protrudes over the top wall 110 of the machine base 100 in the topmost position. In this position, the shallow ends 315 of the recessed brake portions 312 of the brake 31 force the retaining members 32 to engage the first retaining holes 211, and the spring-loaded locating pin 33 is engaged into the locating hole 123 to lock the brake 31, assuring positive positioning of the riving knife 20, i.e., the riving knife 20 is locked to the machine base 100 in the topmost position.

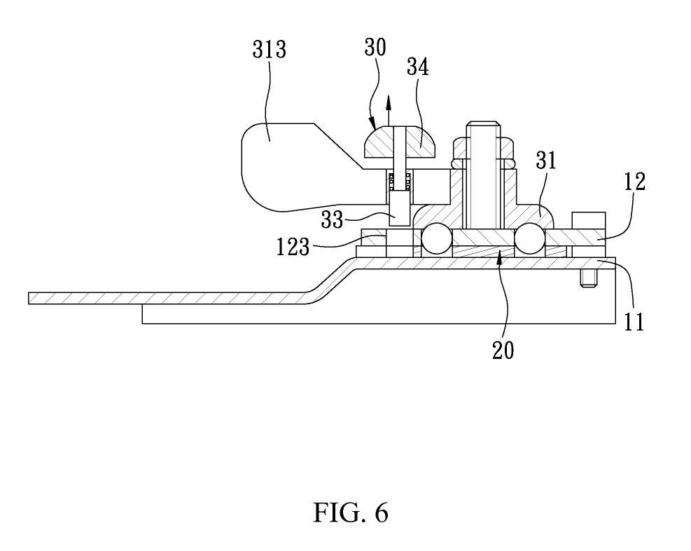

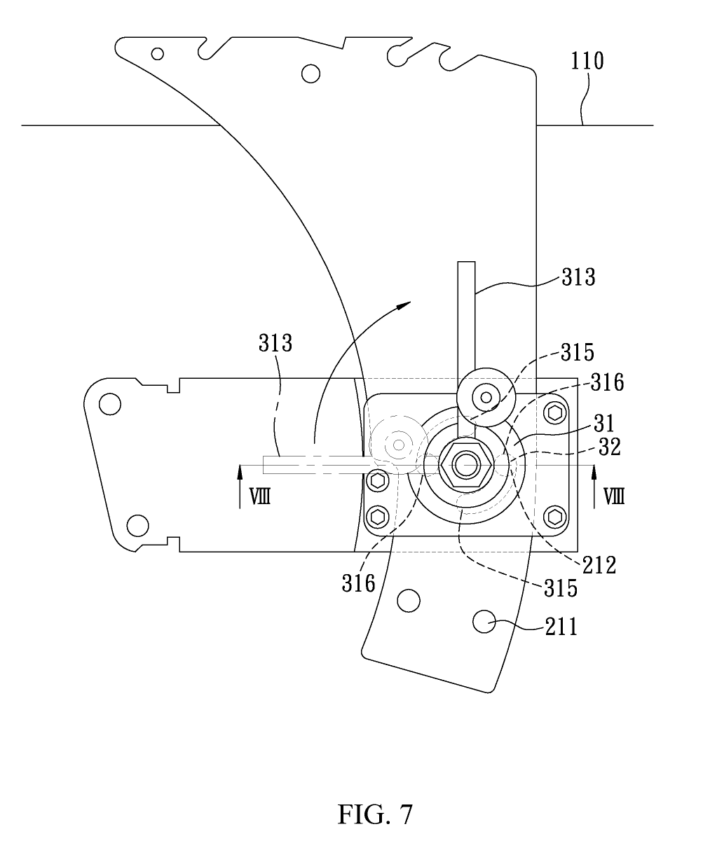

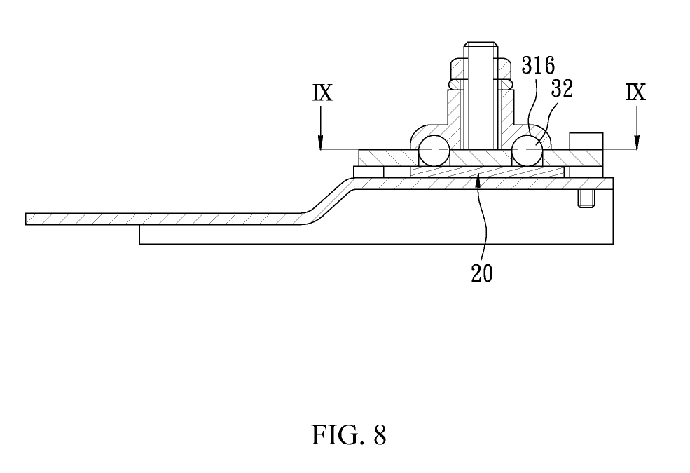

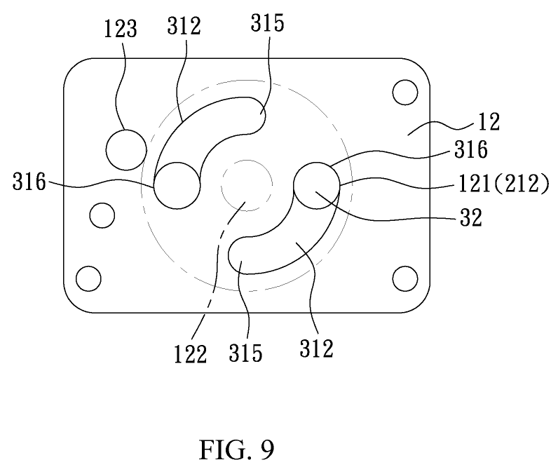

In order to adjust the position of the riving knife 20 or to detach the riving knife 20 from the locating member 10, as shown in FIG. 6, the pull knob 34 of the locking unit 30 is pulled against the force of the spring to disengage the spring-loaded locating pin 33 from the locating hole 123. Next the handle 313 is moved to rotate the brake 31 relative to the constraint plate 12. At this time, as shown in FIGS. 7, 8 and 9, the shallow ends 315 are moved away from the retaining members 32 and the deep ends 316 are moved toward the retaining members 32. Subject to the configuration that the depth of the deep ends 316 is greater than the shallow ends 315, a space is provided in the brake 31 within which the retaining members 32 are movable. At this time, the riving knife 20 can be moved relative to the top wall 110 from the topmost position to the lowest position to disengage the first retaining holes 211 from the retaining members 32 and to move the second retaining holes 212 into alignment with the retaining members 32, enabling the retaining members 32 to be engaged into the second retaining holes 212.

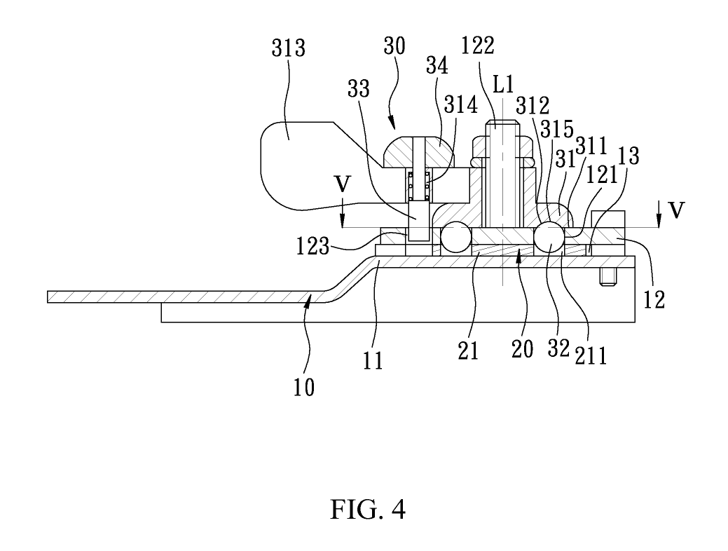

At this time, the operator can reverse the brake 31 to move the shallow ends 315 of the recessed brake portions 312 to the retaining members 32, thereby returning to the braking position shown in FIG. 4. At this time, the spring-loaded locating pin 33 is automatically biased into the locating hole 123 to lock the brake 31, and thereafter the riving knife 20 is locked in position.

By means of operating the brake 31, the retaining members 32 are controlled to engage the first retaining holes 211 or second retaining holes 212, or to move out of the first retaining holes 211 or second retaining holes 212. Therefore, the operator can adjust the position of the riving knife 20 conveniently. Further, the whole structural configuration of this riving knife adjustment mechanism is quite simple.

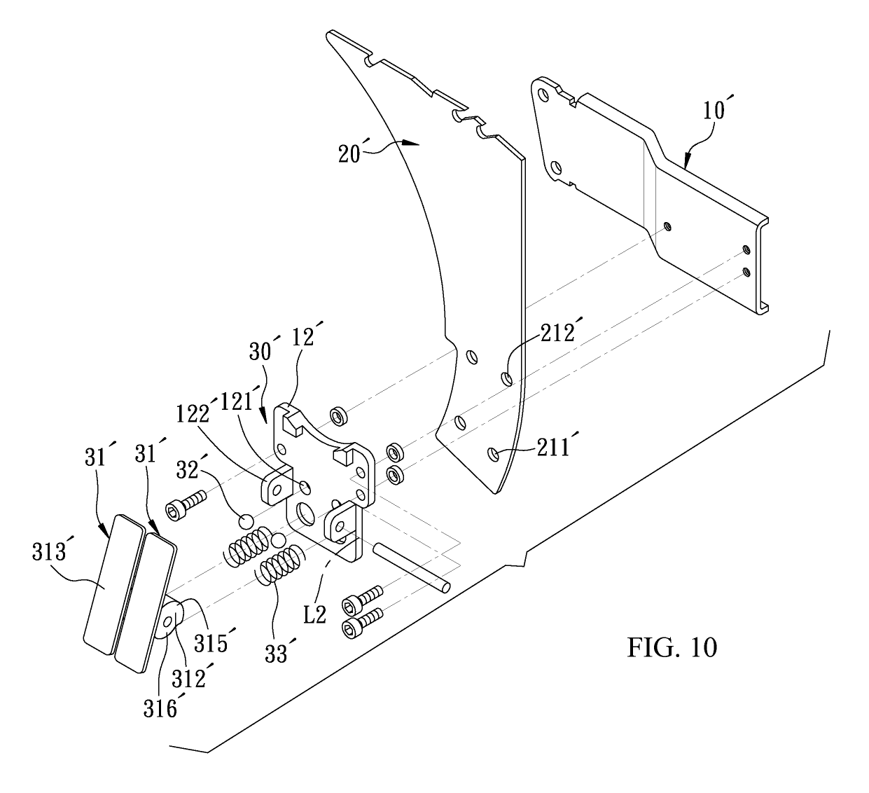

FIG. 10 illustrates a riving knife adjustment mechanism in accordance with a second embodiment of the present disclosure. Similarly to the first embodiment, the riving knife adjustment mechanism according to this second embodiment also includes a locating member 10′, a riving knife 20′, and a locking unit 30′.

The constraint plate 12′ of the locating member 10′ has two through holes 121′ and two lugs 122′ disposed at two opposite lateral sides relative to the through holes 121′. The locking unit 30′ includes two brakes 31′ respectively pivotally mounted on the lugs 122′ and rotatable about a second axis L2, two retaining members, for example, steel balls 32′ and two spring members 33′ respectively positioned between the brakes 31′ and the constraint plate 12′.

Each brake 31′ has a brake portion 312′ disposed eccentrically relative to the constraint plate 12′ and a pressure plate 313′ fixedly connected to the brake portion 312′. The brake portion 312′ of each brake 31′ has a wide section 315′ that is spaced from the second axis L2 at a relatively longer distance, and a narrow section 316′ that is spaced from the second axis L2 at a relatively shorter distance. The spring members 33′ are respectively positioned between the pressure plates 313′ of the brakes 31′ and the constraint plate 12′.

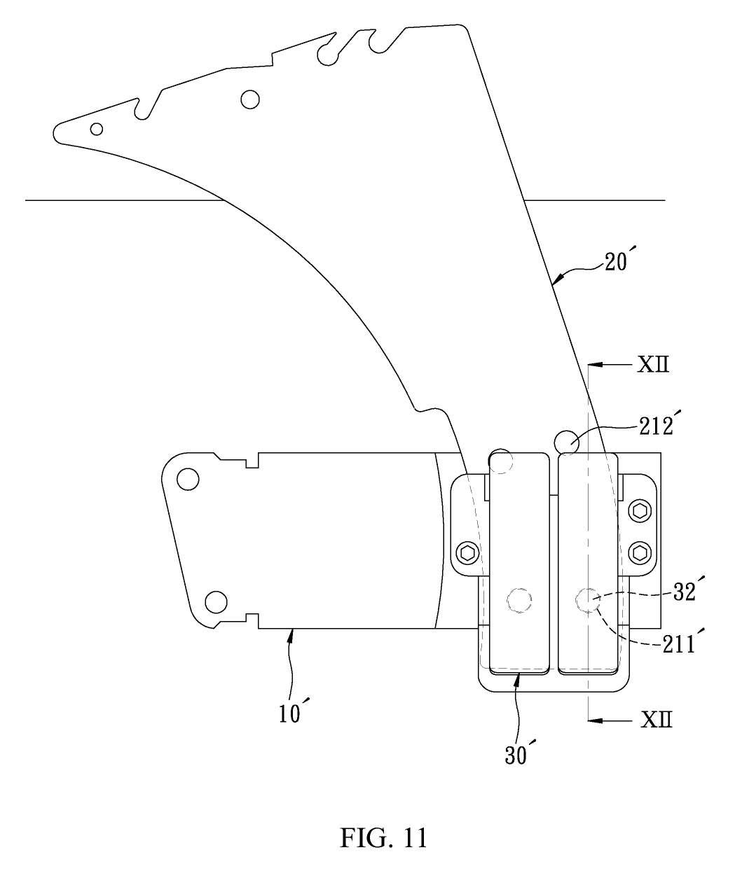

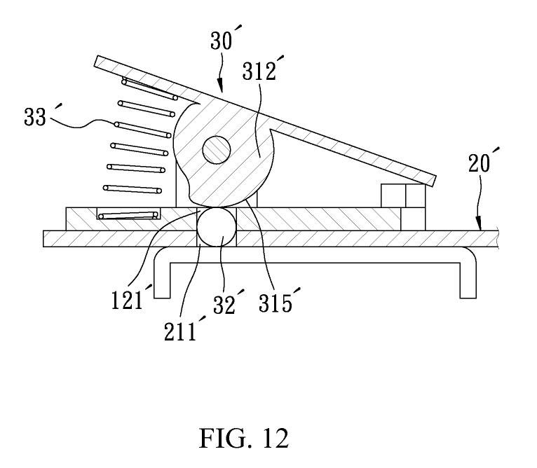

As shown in FIGS. 11 and 12, normally, the spring power of the spring members 33′ forces the wide sections 315′ of the brakes 31′ to stop against the retaining members 32′, causing the retaining members 32′ to pass through the through holes 121′ into the first retaining holes 211′ of the riving knife 20′.

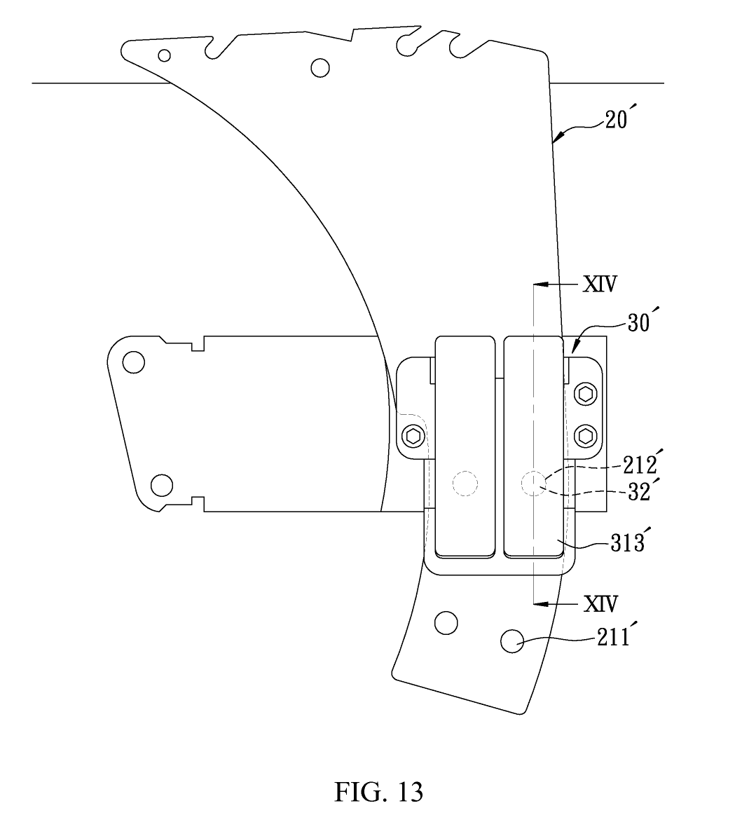

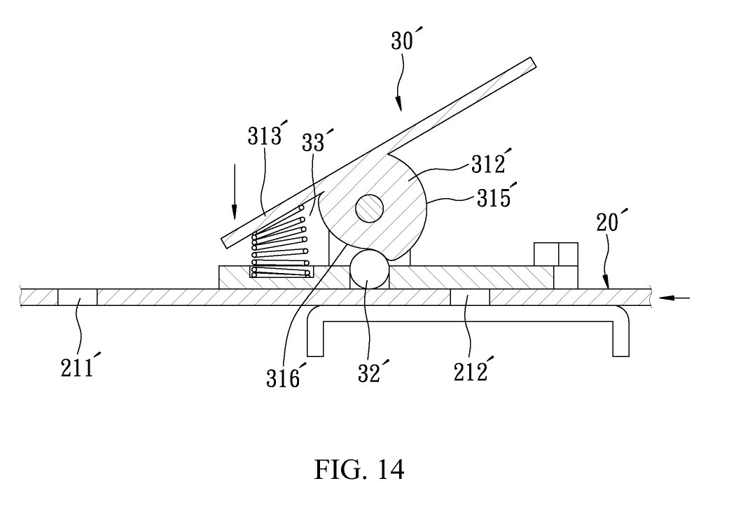

Further, as shown in FIGS. 13 and 14, when the pressure plates 313′ are pressed to move the brake portions 312′ to the position where the narrow sections 316′ of the brakes 31′ are respectively moved to engage the retaining members 32′, the riving knife 20′ is unlocked and can be moved relative to the locating member 10′. When the riving knife 20′ is moved at this time, the retaining members 32′ are forced out of the first retaining holes 211′ of the riving knife 20′.

When the riving knife 20′ is continuously moved to the position where the second retaining holes 212′ are respectively aligned with the retaining members 32′, the pressure is released from the pressure plates 313′ to enable the wide sections 315′ of the brakes 31′ to be forced by the spring members 33′ against the retaining members 32′ to thus move the retaining members 32′ into the second retaining holes 212′ (i.e., returned to the condition shown in FIG. 12), and thereafter the riving knife 20′ is locked in the adjusted position.

Although particular embodiments of the disclosure have been described in detail for purposes of illustration, various modifications and enhancements may be made without departing from the spirit and scope of the disclosure. Accordingly, the disclosure is not to be limited except as by the appended claims

What is claimed is:

1. A riving knife adjustment mechanism for installation on a machine base of a saw machine, the riving knife adjustment mechanism comprising:
a locating member configured to be fixedly mounted in said machine base, said locating member defining a track extending along a longitudinal direction thereof;
a riving knife having a coupling portion slidably inserted into said track of said locating member, said coupling portion having at least one first retaining hole and at least one second retaining hole spaced from said at least one first retaining hole along said longitudinal direction; and
a locking unit having a brake pivotally connected to said locating member and at least one retaining member controllable by said brake to selectively engage the at least one first retaining hole or at least one second retaining hole of said riving knife to lock the riving knife in position, or to move away from the at least one first retaining hole or at least one second retaining hole of said riving knife to allow adjustment of the riving knife.

2. The riving knife adjustment mechanism according to claim 1, wherein said locating member comprises a base member and a constraint plate; said track is defined in between said base member and said constraint plate; the brake of said locking unit is pivotally mounted on said constraint plate; said constraint plate has at least one through hole in communication with said track; and each retaining member is a steel ball.

3. The riving knife adjustment mechanism according to claim 2, wherein the brake of said locking unit is pivotally connected to said constraint plate and rotatable on a first axis, the brake having a bottom wall and at least one recessed brake portion corresponding to said at least one through hole, said at least one recessed brake portion being an arc shaped groove arranged around said first axis and having an opposing shallow end and a deep end, said deep end having a depth greater than a depth of said shallow end; said brake rotatable relative to said constraint plate between a first position where the shallow end of said the at least one recessed brake portion is aligned with said at least one retaining member for causing said retaining member to engage through said at least one through hole into said at least one first retaining hole or said at least one second retaining hole, and a second position where the deep end of said at least one recessed brake portion is aligned with said at least one retaining member for enabling said at least one retaining member to move out of said at least one first retaining hole or said at least one second retaining hole.

4. The riving knife adjustment mechanism according to claim 3, wherein said locating member further comprises a locating hole disposed at one side relative to said track; said locking unit further comprises a spring-loaded locating pin movable between a locking position, where said spring-loaded locating pin is engaged with said locating hole to lock said brake to said locating member and an unlocking position where said spring-loaded locating pin is disengaged from said locating hole for allowing said brake to be rotated relative to said locating member.

5. The riving knife adjustment mechanism according to claim 2, wherein said locating member further comprises two lugs; said brake of said locking unit is mounted on said lugs rotatable about a second axis, having at least one brake portion disposed eccentrically relative to said constraint plate and at least one pressure plate fixedly connected to said at least one brake portion, said at least one brake portion having a wide section spaced from said second axis at a relatively longer distance and a narrow section spaced from said second axis at a relatively shorter distance, said at least one pressure plate operable to move said at least one brake portion between two positions to force said at least one retaining member to selectively engage said at least one retaining hole or said at least one second retaining hole, or to allow said at least one retaining member to be moved out of said at least one retaining hole or said at least one second retaining hole.

6. The riving knife adjustment mechanism as claimed in claim 5, wherein said locking unit further comprises at least one spring member positioned between said at least one pressure plate and said constraint plate to bias the wide section of each said brake portion toward said constraint plate.

7. A riving knife adjustment mechanism for installation on a machine base of a saw machine, the riving knife adjustment mechanism comprising:
a locating member configured to be fixedly mounted in said machine base, said locating member comprising a base member, a constraint plate affixed to said base member and a track defined between said base member and said constraint plate and extending along a longitudinal direction thereof, said constraint plate having at least one through hole in communication with said track;
a riving knife having a coupling portion slidably inserted into said track of said locating member, said coupling portion having at least one first retaining hole; and
a locking unit having a brake pivotally connected to said constraint plate and at least one retaining member controllable by said brake to engage through said at least one through hole into the at least one first retaining hole of said riving knife or to move away from said at least one first retaining hole.

8. The riving knife adjustment mechanism according to claim 7, wherein said brake of said locking unit is mounted on said constraint plate and rotatable about a first axis, the brake having a bottom wall facing said constraint plate and at least one recessed brake portion located on said bottom wall corresponding to said at least one through hole, said at least one brake portion being an arc shaped groove arranged around said first axis and having an opposing shallow end and a deep end, said deep end having a depth greater than a depth of said shallow end; said brake rotatable relative to said constraint plate between a first position where the shallow end of said at least one recessed brake portion is aligned with said at least one retaining member for causing said at least one retaining member to engage through said at least one through hole into said at least one first retaining hole, and a second position where the deep end of said at least one recessed brake portion is aligned with said at least one retaining member for enabling said at least one retaining member to move out of said at least one first retaining hole.

9. The riving knife adjustment mechanism according to claim 8, wherein said locating member further comprises a locating hole disposed at one side relative to said track; said locking unit further comprises a spring-loaded locating pin mounted in said brake and operable to move between a locking position, where said spring-loaded locating pin is engaged with said locating hole to lock said brake to said locating member, and an unlocking position where said spring-loaded locating pin is disengaged from said locating hole for allowing said brake to be rotated relative to said locating member.

10. The riving knife adjustment mechanism according to claim 7, wherein said locating member further comprises two lugs; said brake of said locking unit is mounted on said lugs rotatable relative to said locating member about a second axis, having at least two brake portions disposed eccentrically relative to said constraint plate and at least one pressure plate respectively affixed to said at least one brake portion, each said brake portion having a wide section spaced from said second axis at a relatively longer distance and a narrow section spaced from said second axis at a relatively shorter distance, said at least one pressure plate being operable to move said at least one brake portion, said at least one pressure plate being operable to move said at least one brake portion between two positions to force said at least one retaining member to selectively engage said at least one retaining hole or to allow said at least one retaining member to be moved out of said at least one retaining hole.
